(19) United States
(12) Patent Application Publication
(10) Pub. No.: US 2018/0264440 A1
(43) Pub. Date: Sep. 20, 2018

(54) A COMPOSITE PHOTOCATALYST, PREPARATION METHOD HEREOF AND USE THEREOF

(71) Applicant: UNIVERSITY OF SHANGHAI FOR SCIENCE AND TECHNOLOGY, Shanghai (CN)

(72) Inventors: Xianying WANG, Shanghai (CN); Junhe YANG, Shanghai (CN)

(21) Appl. No.: 15/763,239

(22) PCT Filed: Oct. 26, 2016
(86) PCT No.: PCT/CN2016/103370

§ 371 Date: Mar. 26, 2018

(30) Foreign Application Priority Data
Oct. 26, 2015 (CN) 201510700829.7

(51) Int. Cl. B01J 23/06; B01J 21/06; B01J 21/18; B01J 35/00; B01J 37/02; B01J 37/34; C02F 1/32; C02F 1/72

(52) U.S. Cl. CPC B01J 23/06; C02F 2101/308; B01J 21/18; B01J 21/185; B01J 35/0006; B01J 35/0013; B01J 35/004; B01J 37/0215; B01J 37/343; B01J 37/0236; B01J 37/0238; C02F 1/32; C02F 1/725; C02F 2305/10; B01J 21/063

(57) ABSTRACT

A composite photocatalyst, preparation and use thereof are disclosed. The composite photocatalyst is composed of metal oxide and quantum dot material. Based on the photocatalyst, the percentage content of the metal oxide is from 80 to 99.99% by mass, and the percentage content of the quantum dot material is form 0.01 to 20% by mass. The metal oxide is zinc oxide or titanium oxide. The quantum dot material is graphene quantum dot or carbon quantum dot. The preparation is that the metal oxide and quantum dot material are stirred, mixed, ultrasonicated and dried in sequence, and the photocatalyst is obtained. Compared with other photocatalysts, the catalyst has higher catalytic efficiency and faster catalytic rate for Rhodamine B and provides more sufficient and more comprehensive utilization of sunlight.

### TECHNICAL FIELD

The present invention relates to a photocatalyst, preparation method thereof and use thereof, and more particularly, it relates to a composite photocatalyst, preparation method thereof and use thereof.

### BACKGROUND ART

Photocatalytic technique plays an important role in photocatalytic environment purification, photocatalytic hydrogen production from water, and photocatalytic conversion of carbon dioxide into renewable fuels. The photocatalytic materials are required to be prepared in a simple synthesis process and have good chemical stability, so as to be used widely. In recent years, using photocatalytic technology to degrade dye wastewater is becoming a research focus. Photocatalytic technology is featured by nontoxicity and harmlessness, low cost, high activity, easy operation and reusability, and the like. Meanwhile, this technology can effectively destroy many pollutants which have stable structure and are difficult to be biodegraded. Compared with conventional water treatment technology, photocatalytic technology has obvious advantages, and has become an environmental treatment method which has an important application prospect, bringing widespread attention of scholars home and abroad. At present, TiO₂ is one photocatalytic material mainly used at home and abroad, and is an inherently excellent photocatalytic material due to the characteristics of low-cost, good physical properties, biocompatibility, and the like. However, the wide band gap (3.2 eV) of TiO₂ deteriorates its light absorption property, resulting that TiO₂ can only absorb light of ultraviolet band that accounts for only 5% of sunlight, which greatly reduces the utilization of sunlight. Another widely used photocatalyst in recent years is zinc oxide having many different kinds of nanostructures. However, the band gap of zinc oxide is 3.37 eV, which has the same limitations as TiO₂ in the application of photocatalysis. In addition, zinc oxide, as a photocatalyst, has many drawbacks such as poor resistant to photocorrosion, strict requirements on environmental pH value, and the like. The common means for solving the above problems include doping and surface modifying, so as to adjust the band structure and improve the properties.

Although metal oxides with nanostructure are highly recommended for their excellent characteristics such as large specific surface area, suitable band gap, being easy to be prepared, there are still some drawbacks in themselves. At the same time, graphene with two-dimensional structure is the first choice for preparing zinc oxide nano-composite materials, due to its large specific surface area and excellent electrical and thermal conductivity properties. The direct band gap and single atomic layer structure of the material greatly enhances the utilization of sunlight, especially the utilization of visible wavelengths, and thus enhances the photocatalytic efficiency. Therefore, a perfect combination of these two materials will make a composite photocatalyst having high catalytic properties.

Chinese patent publication CN102921416A discloses a method for preparing a novel photocatalytic material and use thereof, wherein graphene and zinc oxide nanoparticles are compounded through a hydrothermal method. The use of superior electronic conductivity of graphene promotes the photoinduced carrier transferring of zinc oxide, which leads to an efficient separation of electrons and holes, thereby enhancing the photocatalytic properties of zinc oxide. The composite has good adsorption capacity for Rhodamine B, and good effect of visible light induced photocatalytic degradation. The nanocomposite photocatalytic material has a strong adsorption capacity for UV-Vis region of 200-800 nm, and the absorbance exceeds 0.6. In the darkness, the adsorption rate of nanocomposites for organic dye exceeds 20%, and under visible light irradiation, more than 50% of the organic dye Rhodamine B can be degraded within 2 hours. The removal rate of the photocatalytic nanocomposite material for organic dye Rhodamine B is more than 75%.

Chinese patent publication CN1472007A discloses a composite photocatalyst of sulfate and titanium oxide. This composition is visible light-active and can be photoexcited by visible light having wavelength of 387-510 nm, thereby increases the activity of Ti⁴⁺, i.e., the ability to capture photo-generated electrons. The surface hydroxyl or oxo anion radical traps photo-generated holes, and decreases the rate of recombination of the photo-generated electron-hole pair, thus improves the degradation of organic pollutants.

None of the above two publications discloses the formulations of those composite photocatalysts, as well as the shortcomings and deficiencies such as low utilization efficiency of light, easy recombination of photo-generated electrons and holes, and requirement for precious metal as co-catalyst.

### SUMMARY

The present invention aims to solve a technical problem providing a composite photocatalyst, preparation method thereof and use thereof, which is able to utilize the full range of sunlight and delay the fast recombination of photoinduced carriers, and degrade organics quickly without the help of any other co-catalysts.

To solve the above-mentioned technical problem, the technical solution of present invention is to provide a composite photocatalyst, composed by metal oxides and quantum dot materials, wherein, based on said photocatalyst, the percentage content of the metal oxides is from 80 to 99.99% by mass, and the percentage content of the quantum dot materials is from 0.01 to 20%.

The said composite photocatalyst, wherein based on said photocatalyst, the percentage content of the metal oxides is from 90 to 99.99% by mass, and the percentage content of the quantum dot materials is from 0.01 to 10% by mass.

The said composite photocatalyst, wherein said metal oxide is zinc oxide or titanium oxide, and said quantum dot materials is graphene quantum dots or carbon quantum dots.

The said composite photocatalyst, wherein said metal oxide has a structure of irregular nano sheets, said metal oxide has a size of 10 to 900 nm and a thickness of 10 to 50 nm; said quantum dot materials has a structure of round nano sheet, said quantum dot materials has a size of 5 to 50 nm and a thickness of 0.6 to 5 nm.

To solve the above-mentioned technical problem, the technical solution of present invention is also to provide a method for preparing a composite photocatalyst, comprising steps of: preparing nanoscale metal oxides and quantum dot materials; mixing the metal oxides and the quantum dot material in liquid phase in mass ratio of 80˜99.99%: 20˜0.01%, and stirring the mixture for 10 to 60 minutes; treating the mixture with ultrasonic for 30 to 90 minutes at frequency of 100˜200 W, and drying the mixture at temperature of 50˜100° C., so as to obtain the composite photocatalyst. The said method for preparing a composite photocatalyst, wherein the metal oxide is prepared by using chemical vapor deposition, hydrothermal method, pulsed laser deposition or molecular beam epitaxy deposition, and the quantum dot materials is prepared by hydrothermal method, microwave radiation method, solvothermal method or etching method.

The said method for preparing a composite photocatalyst, wherein the metal oxide is prepared by using chemical vapor deposition as follows: the metal oxide powder having purity of 99.99% and carbon powder having purity of 99.99% are mixed in a mass ratio of 1:10 to 10:1, the mixture is added with phosphorus pentoxide with mass content of 2.5 to 25%, and a chemical vapor deposition is carried out using noble metal-plated Al₂O₃ or silicon wafer as substrate.

The said method for preparing a composite photocatalyst, wherein the chemical vapor deposition for preparing the metal oxides comprises is carried out under the following parameters: a growth temperature of 800 to 1000° C., a growth time period of less than 15 minutes, a heating rate of 40° C./min, an argon flow rate of 10 to 120 sccm and an oxygen flow rate of 10 to 80 sccm.

To solve the above-mentioned technical problem, the technical solution of present invention is also to provide use of said composite photocatalyst for photocatalytic degradation of Rhodamine B.

Compared to prior art, the present invention has the following-mentioned advantages. The present invention provides a composite photocatalyst, preparation method thereof and use thereof, wherein materials suitable for photocatalytic application, i.e. metal oxides and graphene materials are compounded to obtain a composite having suitable band gap for photocatalytic applications. As a result, the composite of the two materials not only realizes the full range of absorption of sunlight wavelength, but also improves the photoelectric conversion efficiency, inhibits carrier recombination, so as to improve the photocatalytic efficiency comprehensively. Since materials selected are commonly and widely used metal oxides, the raw materials are easy to get and the cost is low and preparation process is simple. The composite photocatalyst of the present invention has a good catalytic effect under both ultraviolet light and visible light. Also, it is effectively adapted for large-scale industrial production and large-scale water treatment. Both metal oxides and graphene quantum dot have huge surface area due to the two-dimensional structure and are of high chemical stability. Small amount of them could bring high catalytic effect. The catalyst of the present invention can be effectively incorporated into any existing deep process for water treatment, and has a high recovery rate, and therefore it has great environmental significance and value. Compared with other photocatalysts, the catalyst of the present has higher catalytic efficiency and faster catalytic rate for Rhodamine B, provides a more sufficient and more comprehensive utilization of sunlight.

### BRIEF DESCRIPTION OF THE DRAWINGS

FIG. 1 illustrates a SEM image of ZnO nanosheets of present invention;

FIG. 2 illustrates a TEM image of GQDs of present invention at a magnification of 790000×;

FIG. 3 illustrates a TEM image of ZnO-GQDs composite photocatalyst of present invention at a magnification of 790000×;

FIG. 4 illustrates a XPS (X-ray photoelectron spectroscopy) diagram of ZnO-GQDs composite photocatalyst of present invention;

FIG. 5 illustrates light absorption curves of ZnO-GQDs composite photocatalyst of present invention, pure ZnO, and pure GQDs powder;

FIG. 6 illustrates photocurrent curves of ZnO-GQDs composite photocatalyst of present invention, pure ZnO, and pure GQDs powder;

FIG. 7 illustrates an absorption curve using ZnO-GQDs composite photocatalyst of present invention in degradation of Rhodamine B;

FIG. 8 illustrates degradation curves using ZnO-GQDs composite photocatalyst of present invention, and pure ZnO solid powder in degradation of Rhodamine B;

FIG. 9 illustrates calculated reaction kinetic curves using ZnO-GQDs composite photocatalyst of present invention, and pure ZnO solid powder in degradation of Rhodamine B;

FIG. 10 illustrates bar graphs using ZnO-GQDs composite photocatalyst of present invention, and pure ZnO solid powder in degradation of Rhodamine B.

### EXEMPLARY EMBODIMENTS OF THE INVENTION

The present invention will be described in more detail with reference to drawings and embodiments.

As embodiments, the composite photocatalyst according to the present invention, based on the mass of metal oxides and quantum dot materials, comprises 2%, 4%, 7%, 9%, and 11% by mass of quantum dot materials, respectively.

As an embodiment, the metal oxide is zinc oxide.

As an embodiment, the quantum dot material is graphene quantum dots.

As an embodiment, the zinc oxide has a structure of irregular nano sheet, which has a size of 10 to 900 nm and a thickness of 10 to 50 nm.

As an embodiment, the graphene quantum dots has a structure of round nano sheet, which has a size of 5 to 50 nm and a thickness of 0.6 to 5 nm.

A preparation method of the above-mentioned composite photocatalyst comprising steps of:

1. Preparing zinc oxide nanosheets using traditional chemical vapor deposition as follows:

(1) Equal mass of zinc oxide powders and graphite powders were mixed and grinded, the mixture was then added with 2.5% of phosphorus pentoxide, and the resulted mixture was placed in a quartz boat;

(2) An Au-film-coated Al₂O₃ substrate was arranged on the powders in the quartz boat, and together with the quartz boat, was placed into a quartz glass tube;

(3) The quartz glass tube was placed in a tube furnace, and was aligned with thermocouple in the center of the furnace;

(4) Heating to 1000° C. with a heating rate of 40° C./min;

(5) Argon gas (Ar) and oxygen (O₂) were flowed with a flow rate of 70 sccm and 30 sccm, respectively, and maintain the growth time for 5 minutes;

(6) Keep the gas flowing until the mixture is cooled to room temperature naturally;

(7) The white materials resulted on the substrate are zinc oxide nano sheets.

2. Preparing graphene quantum dots using graphene as raw material.

3. Preparing the composite photocatalyst as follows:

The metal oxides obtained in step 1 and graphene quantum dots obtained in step 2 were mixed, and added with absolute ethanol and deionized water, stirring for 30 minutes. After mixing, the mixture was subject to ultrasonic for 30 minutes at a frequency of 200 W. Then, the mixture is dried at a temperature of 60° C. for 24 hours to obtain the composite photocatalyst, i.e. ZnO-GQDs composite photocatalyst.

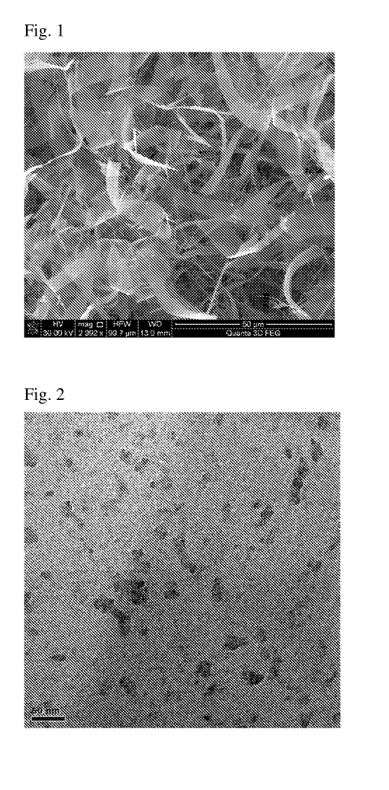

The above-obtained ZnO nano sheets and ZnO-GQDs composite photocatalyst were subjected to morphology scanning by scanning electron microscope (manufacturer: FEI, Model: Quanta FEG) and transmission electron microscopy (manufacturer: TESEQ, Model: D-TEM), respectively. The SEM image obtained is shown in FIG. 1, where large tracts of ZnO thin nano sheets having irregular shape can be observed.

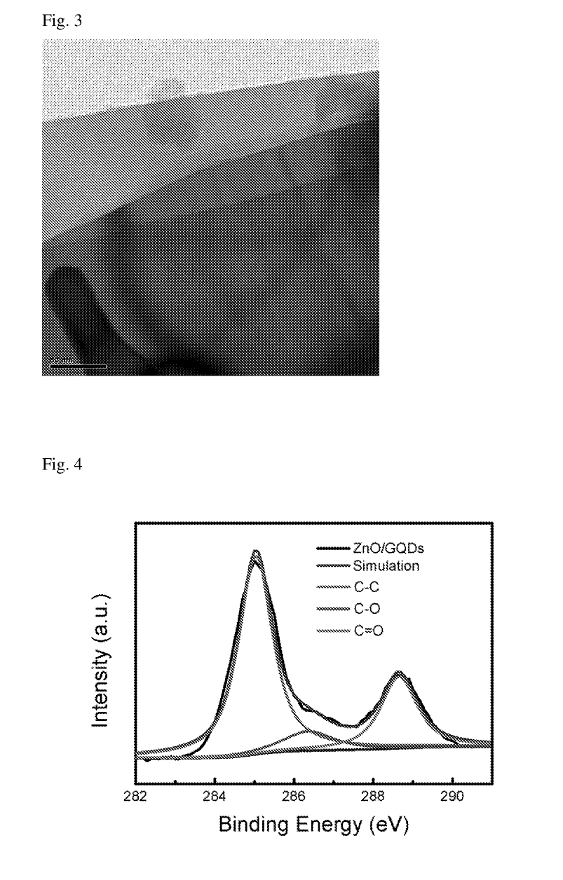

The ZnO nano sheets are very thin and have a large area. The TEM images obtained are shown in FIG. 2 and FIG. 3, wherein the presence of zinc oxide and the graphene quantum dots are observed clearly, and formation of a composite from the two materials is further confirmed from TEM images of FIG. 2 and FIG. 3.

The above-obtained ZnO-GQDs composite photocatalyst is subject to element analysis by X-ray photoelectron spectroscopy (Manufacturer: UK Kratos, model: XSAM 800). The XPS spectra obtained is shown in FIG. 4. It is further proved from XPS spectra of FIG. 4 that graphene quantum dots are present in the obtained photocatalyst according to the present invention.

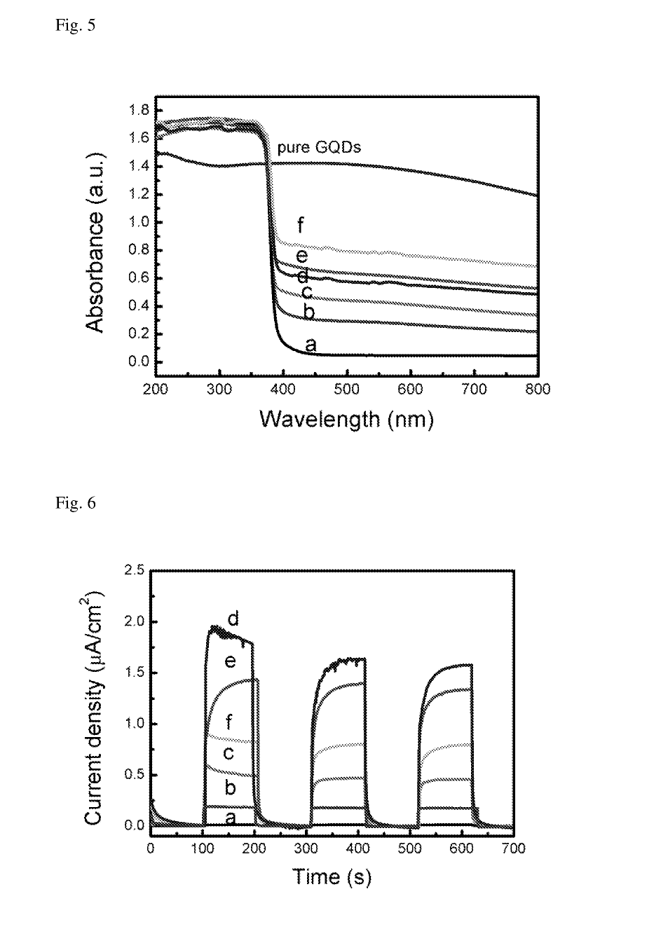

The ZnO-GQDs composite photocatalyst obtained in the above embodiment, as well as pure ZnO and pure graphene quantum dots were measured by UV-visible spectroscopy (Manufacturer: Shimadzu Corporation, model: Shimadzu UV-2600) at room temperature, the resulted light absorption curves are shown in FIG. 5. As can be seen from FIG. 5, compared with pure ZnO, the ZnO-GQDs composite photocatalyst greatly enhances the absorption for visible light, indicating a great improvement of full-band optical absorption for sunlight, and is very favorable for increasing the photocatalytic efficiency.

The ZnO-GQDs composite photocatalyst obtained in the above embodiment, as well as pure ZnO were measured by probe station (Manufacturer: Cascade Microtch, Model: M150) at room temperature, the resulted photocurrent curves are shown in FIG. 6. As can be seen from FIG. 6, compared with pure ZnO, the photocurrent value of ZnO-GQDs composite photocatalyst obtained from the present embodiment is significantly increased under illumination, indicating that the photoelectric conversion efficiency of the present composite photocatalyst are improved to some extent.

Photo Catalysis Experiment

The ZnO-GQDs composite photocatalysts obtained in the embodiment were used for the degradation of the organic Rhodamine B, as steps of follows:

(1) 40 mg of ZnO-GQDs composite photocatalyst obtained in the embodiment and 20 mg of pure ZnO solid powder were respectively added into beakers, and then 40 mL of Rhodamine B aqueous solution having a concentration of 10 mg/L was added respectively.

(2) The beakers in step (1) were placed in a darkroom for 10 minutes, then 5 mL of the mixture was sampled into a centrifuge tube, and then the beakers were transferred to be exposed under a solar radiation (optical density 1800 uV/cm²), the mixture were stirred by a magnetic stirrer, and sampled per 2 minutes.

(3) The centrifuge tubes were centrifuged at a centrifugal speed of 12000 r/min for 10 minutes.

(4) After the centrifugation, the supernatant was subjected to UV-visible spectrometer and was observed for the change of absorbance at about 554 nm, since 554 nm was identified as the characteristic absorption peak of Rhodamine B.

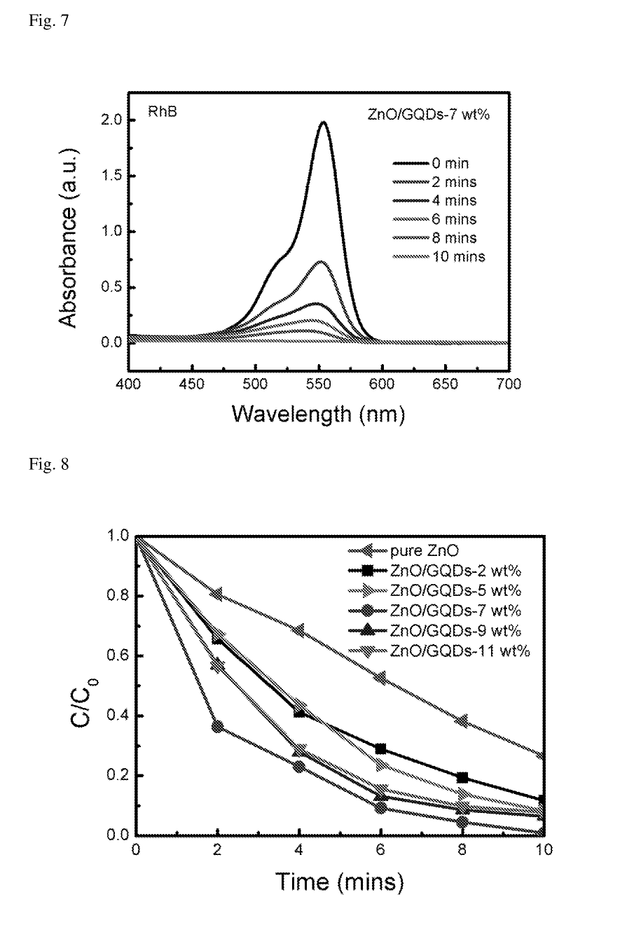

The mass ratio of quantum dot material in the above-obtained ZnO-GQDs composite photocatalyst is 7%. FIG. 7 shows the absorption curve of the degradation of Rhodamine B for the composite photocatalyst. As can be seen from FIG. 7, after 10 minutes of solar radiation, Rhodamine B are degraded completely, indicating a good catalytic effect of the composite photocatalyst.

The degradation curves for degradation of Rhodamine B using ZnO-GQDs composite photocatalysts with 5 various formulations obtained in the embodiment are shown and compared with pure ZnO solid powder for degradation of Rhodamine B in FIG. 8. As can be seen from FIG. 8, the addition of GQDs influences the degradation of Rhodamine B to some extent. With the amount of GQDs increasing, the rate of degradation for Rhodamine B gradually accelerates. However, when the amount of GQDs reaches a certain level, the rate of degradation is constrained to the contrary. The main reason is that the excessive GQDs will deteriorate the light absorption of the composite catalyst, resulting in a decrease of catalytic efficiency. Thus, an addition of GQDs with appropriate amount enhances the photocatalytic efficiency of ZnO significantly.

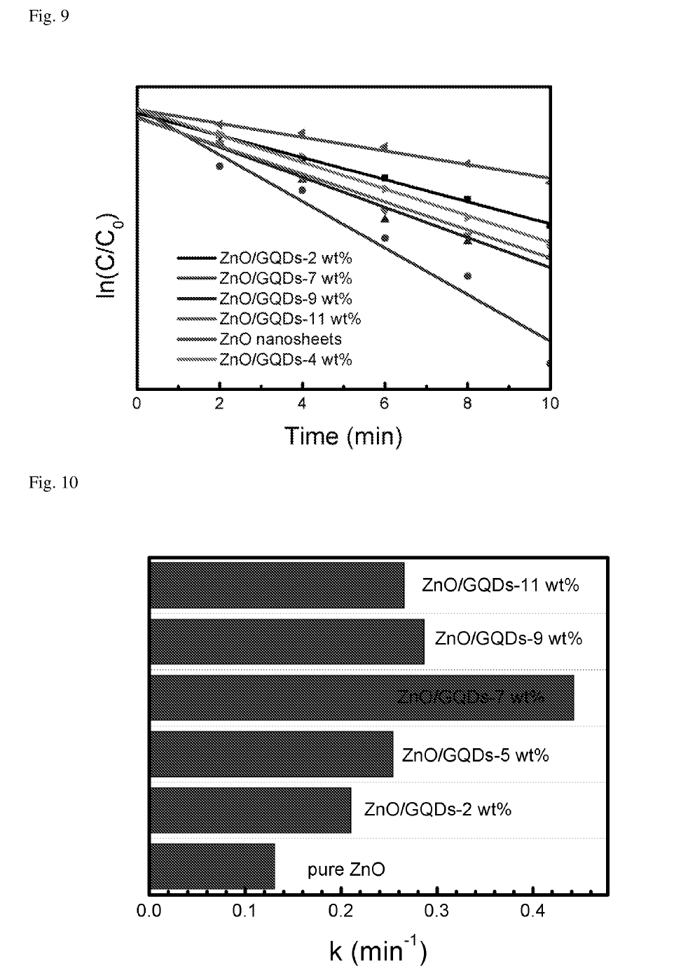

The computing curves of reaction kinetic and bar graphs of degradation of Rhodamine B by ZnO-GQDs composite photocatalysts obtained in the embodiment, as well as by pure ZnO solide powder are shown in FIG. 9 and FIG. 10, respectively. These figures further indicate that an appropriate amount of GQDs enhances the photocatalytic efficiency of ZnO.

In conclusion, the composite photocatalyst composed of the ZnO nano sheets and graphene quantum dots has superior absorption capacity for light, good separation capacity for photoinduced carriers, and good photocatalytic capacity for the degradation of organics.

The catalyst of present invention using the photocatalyst composed by ZnO metal oxide and graphene quantum dots is described as an example only, but is not limited to the above example, and also include a photocatalyst composed by other metal oxides and other quantum dots materials.

In conclusion, photocatalysts of the present invention not only realizes the full range of absorption of sunlight wavelength, but also improves the photoelectric conversion efficiency, inhibits carrier recombination, so as to improve the photocatalytic efficiency comprehensively.

The present invention has been described with a preferred embodiment as described above, and is not limited to the above described embodiment. A person skilled in the art can make improvements and modifications within the spirit and scope of this invention. Therefore, the scope of protection of present invention shall be determined by the terms of the claims.

1. A composite photocatalyst comprising metal oxides and quantum dot materials, wherein the percentage content of the metal oxides is from 80 to 99.99% by mass, and the percentage content of the quantum dot materials is from 0.01 to 20% by mass.

2. The composite photocatalyst according to claim 1, wherein the percentage content of the metal oxides is from 90 to 99.99% by mass, and the percentage content of the quantum dot materials is from 0.01 to 10% by mass.

3. The composite photocatalyst according to claim 1, wherein the metal oxide is zinc oxide or titanium oxide, and the quantum dot materials is graphene quantum dots or carbon quantum dots.

4. The composite photocatalyst according to claim 1, wherein the metal oxide has a structure of irregular nano sheet, the metal oxide has a size of 10 to 900 nm and a thickness of 10 to 50 nm; the quantum dot materials has a structure of round nano sheet a size of 5 to 50 nm and a thickness of 0.6 to 5 nm.

5. A method for preparing a composite photocatalyst, comprising steps of:
preparing nanoscale metal oxides and quantum dot materials;
mixing the metal oxides and the quantum dot materials in liquid phase in a mass ratio of 80 to 99.99%: 20 to 0.01% to form a mixture, and stirring the mixture for 10 to 60 minutes;
treating the mixture with ultrasonic for 30 to 90 minutes at frequency of 100 to 200 W, and
drying the mixture at temperature of 50 to 100° C., so to obtain the composite photocatalyst.

6. The method for preparing a composite photocatalyst according to claim 5, wherein the metal oxide is prepared by using a process selected from the group consisting of chemical vapor deposition, hydrothermal method, pulsed laser deposition and molecular beam epitaxy deposition; and the quantum dot materials is prepared a process selected from the group consisting of hydrothermal method, microwave radiation method, solvothermal method and etching method.

7. The method for preparing a composite photocatalyst according to claim 6, wherein the metal oxide is prepared by using chemical vapor deposition method comprising
mixing the metal oxide powder having purity of 99.99% and carbon powder having purity of 99.99% in a mass ratio of 1:10 to 10:1 to form a mixture,
adding phosphorus pentoxide with mass content of 2.5 to 25% to the mixture, and
carrying out a chemical vapor deposition using noble metal-plated Al₂O₃ or silicon wafer as substrate.

8. The method for preparing a composite photocatalyst according to claim 7, characterized in that wherein the chemical vapor deposition method further comprises a growth temperature of 800 to 1000° C., a growth time period of less than 15 minutes, a heating rate of 40° C./min, an argon flow rate of 10 to 120 sccm, and an oxygen flow rate of 10 to 80 sccm.

9. A method of photocatalytic degradation of Rhodamine B comprising use of the composite photocatalyst according to claim 1,

10. A method of photocatalytic degradation of Rhodamine B comprising use of the composite photocatalyst according to claim

11. A method of photocatalytic degradation of Rhodamine B comprising use of the composite photocatalyst according to claim 3.

12. A method of photocatalytic degradation of Rhodamine B comprising use of the composite photocatalyst according to claim 4.
